(19) United States
(12) Patent Application Publication
(10) Pub. No.: US 2010/0309881 A1
(43) Pub. Date: Dec. 9, 2010

(54) MOBILE COMMUNICATION SYSTEM AND TUNNEL MANAGEMENT METHOD THEREOF

(75) Inventors: Chang Ki Kim, Daejeon (KR); Young Jick Bahg, Daejeon (KR)

Correspondence Address: LAHIVE & COCKFIELD, LLP;FLOOR 30, SUITE 3000, ONE POST OFFICE SQUARE, BOSTON, MA, 02109, US

(73) Assignees: SAMSUNG ELECTRONICS CO., LTD., Suwon-Si, Gyeonggi-Do (KR); ELECTRONICS AND TELECOMMUNICATIONS RESEARCH INSTIT, DAEJEON (KR)

(21) Appl. No.: 12/745,528

(22) PCT Filed: Jul. 29, 2008
(86) PCT No.: PCT/KR08/04412

§ 371 Date: May 28, 2010

(30) Foreign Application Priority Data
Nov. 29, 2007 (KR) 10-2007-0122411

(51) Int. Cl. H04W 4/00; H04L 12/28

(52) U.S. Cl. 370/331

(57) ABSTRACT

The present invention relates to a mobile communication system and a tunnel management method thereof. In the tunnel management method, tunnel information update request having a user equipment identifier of the user equipment is received at a serving gateway from a mobility managing device when the user equipment performs handoff. Then, tunnel information is updated by changing address information of data destination for all tunnels having the user equipment identifier.

### TECHNICAL FIELD

The present invention relates to a mobile communication system and a tunnel management method thereof; and, more particularly, to a mobile communication system and a tunnel management method thereof, which manage at least one of tunnels that are established for user equipment using a user equipment identifier assigned to the user equipment when the user equipment performs handoff.

This work was partly supported by the IT R & D program of MIC/IITA [2005-S-404-23, “3G Evolution Access System Development”].

### 2. BACKGROUND ART

A mobile communication network has been commercialized and serviced to public. Such a mobile communication network generally includes user equipment (UE), a node B base station, a Radio Network Controller (RNC), a Serving GPRS Support Node (SGSN), and a Gateway GPRS Support Node (GGSN). Here, GPRS stands for General Packet Radio Service. In order to realize a next generation mobile communication network, a standardization processing for evolved mobile communication access and core network have been in progress.

The evolved mobile communication network supports an Internet Protocol (IP) service in a broadband wireless communication network so as to enable user equipment (UE) to receive the IP service. Such an evolved mobile communication network has been developed from a typical UMTS Terrestrial Radio Access Network (UTRAN). Here, UMTS stands for a Universal Mobile Telecommunications System. The evolved mobile communication network guarantees a low delay rate and a high data transmit rate. The evolved mobile communication network also enables user equipment to easily interwork with a packet data network (PDN).

In order to provide a high data transmit rate and a short delay time, a structure of a current mobile communication network has been simplified. That is, the current mobile communication network is constituted of user equipment, an Evolved UTRAN (E-UTRAN), and an Evolved Packet Core (EPC). Such an evolved mobile communication network provides not only mobility but also comparability in order to enable user equipment to perform handoff to existing networks.

In the evolved mobile communication network, user equipment forms tunnels for traffic to use related services. Such tunnels are managed based on each tunnel identifier (TEID). Since information about access nodes of user equipment is changed whenever handoff is performed in the E-UTRAN, it is necessary to change the information about the access node for each of the TEIDs whenever handoff is performed. Thus, constituent elements thereof must perform many steps for transmitting and receiving data and also frequently transmit and receive data, thereby deteriorating overall system efficiency. Particularly, if user equipment uses a plurality of services at the same time, it is necessary to change information about all access nodes for each tunnel corresponding to the plurality of services. Therefore, system efficiency also deteriorates due to the large number of signaling.

### DISCLOSURE OF INVENTION

### Technical Problem

The present invention provides a mobile communication system and a tunnel management method thereof for improving efficiency and performance of a system by sharing user equipment identifier (UEID) when a tunnel is allocated to use a service, and managing an allocated tunnel using the UEID.

### Technical Solution

In accordance with an aspect of the present invention, there is provided a tunnel management method for a mobile communication system including an evolved radio access network having a plurality of access nodes where user equipment accesses, and a serving gateway connected to a mobility managing device for controlling mobility of the user equipment and for controlling tunnel management and traffic transmission of the user equipment, which includes at the serving gateway, receiving a tunnel information update request having a user equipment identifier of the user equipment from the mobility managing device when the user equipment performs handoff; and updating tunnel information by changing address information of data destination for all tunnels having the user equipment identifier.

In accordance with another aspect of the present invention, there is provided a mobile communication system including an evolved radio access network having a plurality of access nodes accessed to user equipment, and a serving gateway connected to a mobile management device for controlling mobility of the user equipment and for controlling tunnel management of the user equipment and traffic control, in which the serving gateway changes an address of data destination for all tunnels established to the user equipment using a user equipment identifier allocated to the user equipment when the user equipment is transferred to one of the plurality of access notes.

### ADVANTAGEOUS EFFECTS

The mobile communication system and a tunnel management method thereof according to the present invention share a user equipment identifier (UEID) and manage a plurality of tunnels established to user equipment using the UEID. Therefore, it is possible to efficiently perform handoff because the number of processing signals for handoff is reduced. Also, the mobile communication system and a tunnel management method thereof according to the present invention manage tunnels using a tunnel management table including UEIDs. Therefore, it is also possible to conveniently and efficiently manage the tunnel management table for setting up and releasing tunnels, thereby improving system performance.

### BRIEF DESCRIPTION OF THE DRAWINGS

FIG. 1 is a diagram illustrating an evolved mobile communication network in accordance with an embodiment of the present invention.

FIG. 2 is a diagram illustrating connection configuration from an eNodeB to an EPC in accordance with an embodiment of the present invention.

FIG. 3 is a block diagram illustrating an EPC in accordance with an embodiment of the present invention.

FIG. 4 is a diagram illustrating a data structure included in a Serving GW in accordance with an embodiment of the present invention.

FIG. 5 is a flowchart illustrating a method for setting up a tunnel using user equipment identifier (UEID) in accordance with an embodiment of the present invention.

FIG. 6 is a flowchart illustrating a method for managing tunnels corresponding handoff in accordance with an embodiment of the present invention.

### BEST MODE FOR CARRYING OUT THE INVENTION

The advantages, features and aspects of the invention will become apparent from the following description of embodiments with reference to the accompanying drawings.

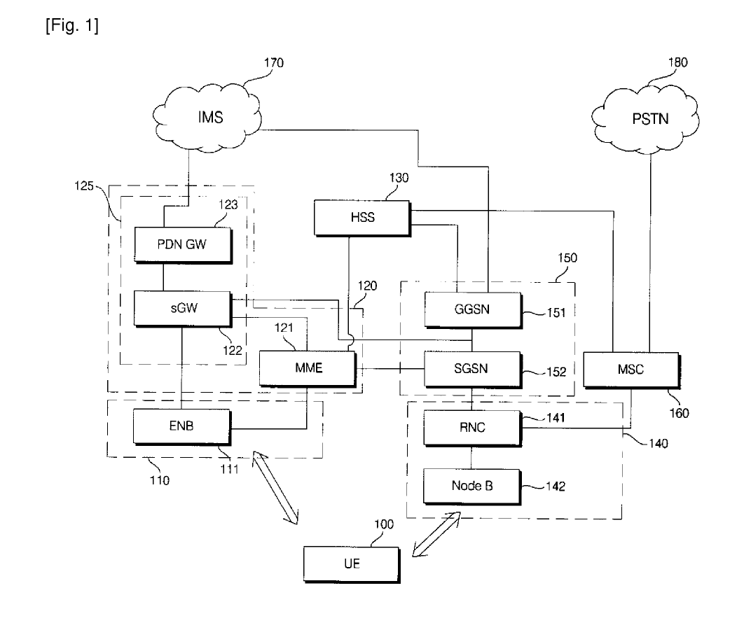

FIG. 1 is a diagram illustrating an evolved mobile communication network in accordance with an embodiment of the present invention.

Referring to FIG. 1, the evolved mobile communication network includes user equipment 100, an Evolved Universal Mobile Telecommunications Network Terrestrial Radio Access Network (E-UTRAN) 110, and an Evolved Packet Core (EPC) 120.

Such an evolved mobile communication network is connected to existing mobile communication networks and a Home Subscriber Server (HSS) 130 for registration, authentication, and verification of users so as to be connected to an IP Multimedia Subsystem (IMS) 170 and a Public Switched Telephone Network (PSTN) 180. The existing mobile communication network includes an UTRAN 140 having a Node B 142 and a Radio Network Controller (RNC) 141 for taking charge of access of user equipment, a core network 150 having a SGSN 152 and a GGSN 151, and a Mobile Switching Center (MSC) 160.

The EUTRAN 110 has been developed from an UTRAN 140 having existing node B and a RNC 141. The EUTRAN 110 includes a plurality of access nodes, Evolved node Bs (ENB) 111, for taking care of access of the UE 100. The EUTRAN 110 is connected to the EPC 120 and to existing mobile communication network through the EPC 120. The UE 100 is equipment that provides an IP Multimedia service such as voice, video, positioning, and an instant message service as well as satisfying performance required by the EUTRAN.

The EUTRAN 110 includes a plurality of ENBs 111. The ENB 111 forms a radio channel to the user equipment 100 in a corresponding cell and allocates and releases radio resources by managing radio resources in a cell unit. The ENB 111 receives an uplink signals transmitted from the user equipment 100 at a physical layer level, and transmits downlink signals to the UE 100. That is, the ENB 111 operates as an access point for enabling the UE 100 to access the EUTRAN 110 by performing operations for transmitting and receiving signals from the UE 100.

The EPC 120 includes at least one of Mobility Management Entities (MME) 121, and at least one of System Architecture Evolution Gateways (SAE GW) 125. The SAE GW 125 includes a Serving Gateway (sGW) 122 and a Packet Data Network Gateway (PDN GW) 123. The SAE GW 125 performs a gateway function for interworking with the Internet or an external packet network. That is, the SAE GW 125 operates as an access point between networks hierarchically connected to the SAE GW 125 and an external Internet. Here, the MME 121, the sGW 122, and the PDN GW 123 may be physically disposed in the same equipment. Or, they may be physically separated. In the present embodiment, it is assumed that the EPC 120, the MME 121 and the SAE GW 125 are physically separated and disposed in different devices.

The MME 121 manages the mobility of the user equipment 100, manages access information of the UE 100, and performs a function for transmitting and receiving a control message of the ENB 111. The MME 121 provides an interface to the HSS 130 for authenticating the UE 100 and performs a Bearer control function. The MME 121 is connected to the HSS 130 and the sGW 122. The MME 121 is also connected to the SGSN 152 when the MME 121 is connected to an existing mobile communication network.

The sGW 122 allocates and manages a tunnel according to a service used by the UE 100. The sGW 122 also performs traffic transmission through the managed tunnel. The sGW 122 performs traffic transmission based on the tunnels and operates as an anchor for local handoff between the ENBs 111. The sGW 122 transmits packets filtered by the PDN GW 123 to the ENB 11 through a tunnel allocated to the UE 100 so as to transmit the data to the UE 100. The sGW 122 is connected to the ENB 111 of the E-UTRAN 110 and connected to the IMS 170 and the Internet through the PDN GW 123. Also, the sGW 122 is connected to the SGSN 152 and the GGSN 151 when an existing mobile communication network is connected.

The PDN GW 123 allocates an IP to the UE 100 and filters data packet which will be traffic. The PDN GW 123 filters only packets transmitted to the UE 100 connected to the ENB 11 which is managed by the PDN GW 123 among user data from an external Internet network.

In such evolved mobile communication network, the MME 121 shares a UEID by transmitting the UEID to the sGW 122 corresponding to service used by the UE 100.

When the UE 100 uses a plurality of services at the same time, traffics for different services are managed using different tunnels by the inside of the EPC 120, particularly, by the sGW 122. Each of the tunnels for using services is assigned with a tunnel identifier (TEID). The sGW 122 manages TEIDs, information about tunnels, and a UEID of UE 100 using corresponding services.

When the UE 100 performs handoff from a first ENB to a second ENB connected to the same MME 121, the MME 121 transmits an UEID, a delimiter of the UE 100, to the sGW 122. The sGW 122 manages tunnels allocated to the UE 100 using the received UEID.

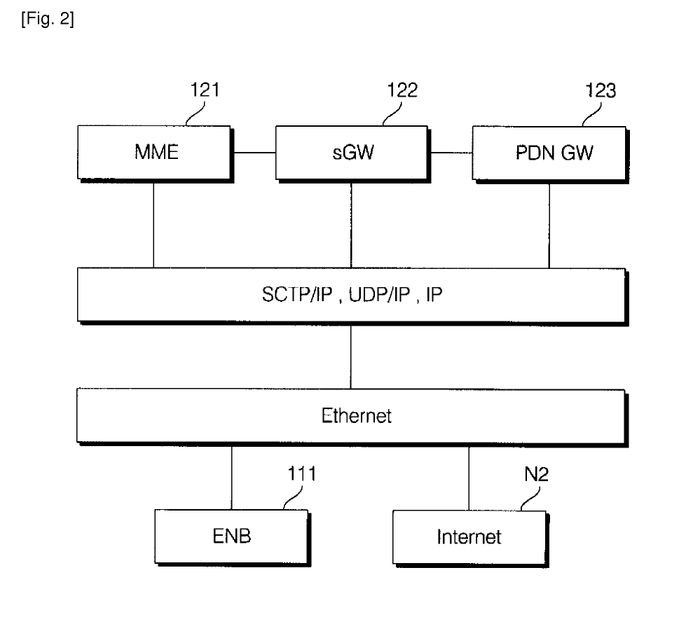

FIG. 2 is a diagram illustrating connection configuration from an eNodeB to an EPC in accordance with an embodiment of the present invention.

Referring to FIG. 2, the EPC 120 includes a MME 121, a sGW 122, and a PDN GW 123 as described above. When the UE 100 is connected to and communicate with the EBN 111, the ENB 111 of the EUTRAN 110, the MME 121 of the EPC 120, the sGW 122, and the PDN GW 123 communicate as follows.

The MME 121 transmits control information for authentication, bearer management, and mobility management for a data service of the UE 100 connected to the ENB 111 by communicating with the ENB 111 through Stream Control Transmission Protocol/Internet Protocol (SCTP/IP) using SI-AP which is a control protocol. The sGW 122 transmits data of the UE 100 by communicating with the ENB 111 through UDP/IP using GTP-U which is a traffic protocol. The PDN GW 123 communicates with the Internet network N2 through IP.

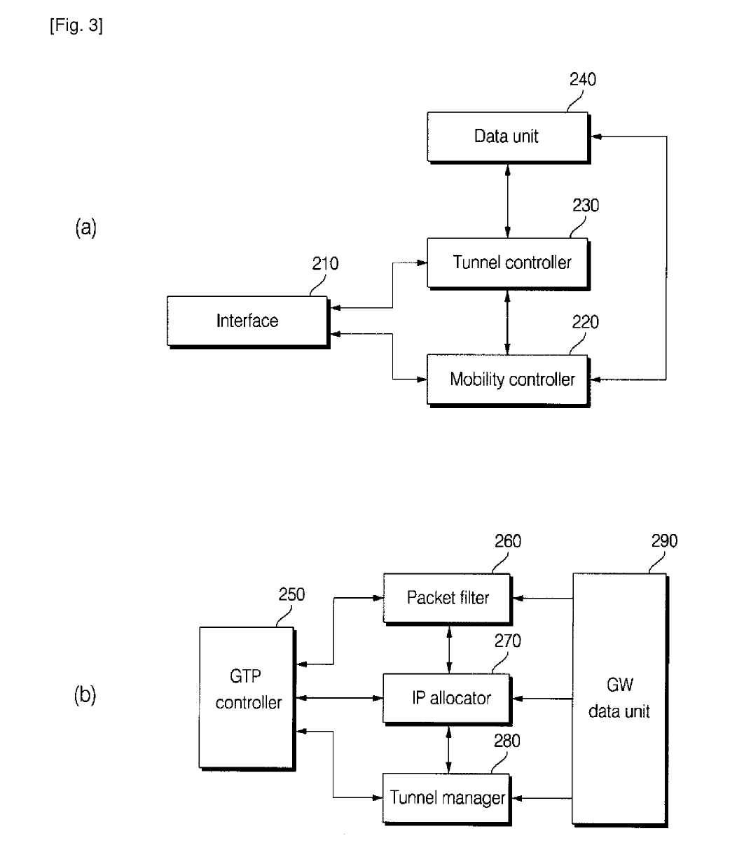

FIG. 3 is a block diagram illustrating an EPC in accordance with an embodiment of the present invention.

Referring to a) of FIG. 3, the MME 121 includes an interface 210 for communicating with an ENB which is an access point of UE 100, a mobility controller 220 for managing mobility and sessions of the UE 100 by performing a function of transmitting and receiving a control message of the ENB 111 through the interface 210, a tunnel controller 230 for controlling a tunnel for transmitting data of the UE 100, and a data unit 240 for storing information according to the access of the UE 100.

Referring to b) of FIG. 3, the SAE GW 125 includes a tunnel manager 280, a GTP controller 250, a packet filter 260, an IP allocator 270, and a GW data unit 290. The tunnel manager 280 allocates and manages a tunnel when the UE 100 uses a service. The tunnel manager 280 also routes and forwards filtered packet data. The GTP controller 250 controls traffic transmission through the tunnel. The packet filter 260 filters only packet data to the UE 100 connected to the ENB 111 among data received from an external device. The IP allocator 270 allocates an IP to the UE 100. The GW data unit 290 temporally stores packet data and information on the connected UE 100.

The GTP controller 250 and the tunnel manager 280 are included in the sGW 122, and the IP allocator 270 and the packet filter 260 are included in the PDN GW 123.

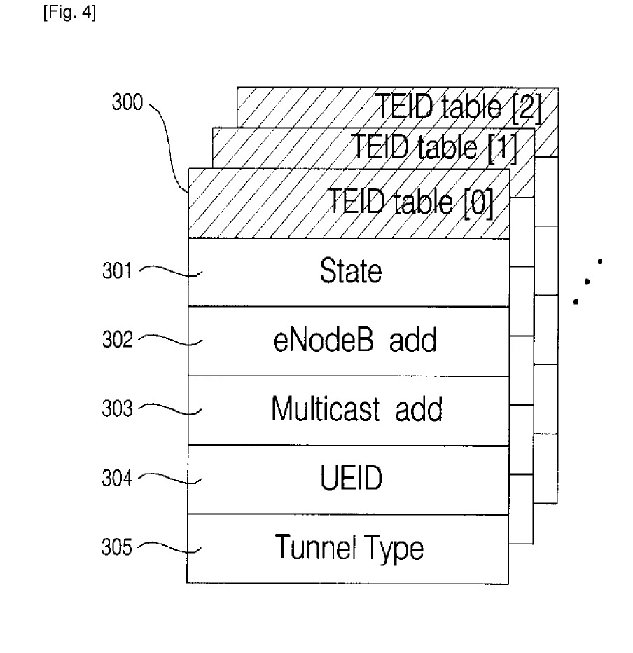

FIG. 4 is a diagram illustrating a data structure included in a Serving Gate Way (sGW) in accordance with an embodiment of the present invention.

Referring to FIG. 4, the sGW 122 controls the tunnel manager 280 and the GTP controller 250 to allocate a tunnel to UE 100, to manage the allocated tunnel and to transmit data packets through the tunnel.

The tunnel manager 280 of the sGW 122 stores a tunnel management table in the GW data unit 290 as shown in FIG. 4, thereby managing tunnels established for the UE 100. The tunnel management table includes information for transferring user data using a logical path between the sGW 122 and the ENB.

The tunnel manager 280 generates a tunnel, assigns a tunnel identifier (TEID) 300, and stores an ENB address (eNodeB Add) 302 which is an address of data destination, a multicast address (Multicast Add) 303, a user equipment identifier (UEID) 304, and a tunnel type 305 with the assigned TEID in the tunnel management table. The tunnel manager 280 assigns one TEID to one tunnel and manages tunnels by a TEID unit.

The tunnel management table includes state information (STATE) 301, ENB address (eNodeB add) 302, a multicast address (Multicast add) 303, a user equipment ID (UEID) 304, and a tunnel type (Tunnel Type) 305. The STATE 301 refers to states of traffic that uses a tunnel. That is, the STATE 301 denotes an active state or a null state. The eNodeB add 302 refers to an address of an ENB connected to UE 100 that is established with a tunnel to a destination address of a data packet. The Multicast add 303 is an address for multicasted data packet. The UEID 304 is unique information allocated for identifying UE 100. The UEID 304 is used for allocating and releasing a tunnel and performing handoff. The Tunnel Type 305 refers whether user data of a corresponding tunnel is unicast data or multicast data. The sGW 122 receives an UEID from the MME 121 when a tunnel is established for the UE 100. For the tunnel established for the UE 100, the sGW 122 manages an UEID by storing the UEID in a tunnel management table with the TEID.

When the MME 121 requests the sGW 122 to change configuration as the UE 100 performs handoff, the sGW 122 searches an UEID received from the MME 121 and a TEID including an UEID corresponding to an address of new assigned ENB after handoff. Then, the sGW 122 updates a tunnel management table to change an address of data destination for all of the searched tunnels. That is, the sGW 122 updates the tunnel management table to change an address of an ENB connected to the UE 100. The sGW 122 transfers traffic of a tunnel in use to the changed ENB based on the changed ENB address so as to provide a service to the UE 100.

The MME 121 requests the sGW 122 to change configuration with an UEID, and the sGW 122 manages all of tunnels allocated to UE 100 with handoff performed using the received UEID. Here, the MME 121 transmits an UEID to the sGW 122 in order to update an ENG address for a plurality of tunnels established for the UE 100 when the UE 100 performs handoff between ENBs connected at the same MME 121.

Operations of a mobile communication system according to the present embodiment will be described as follows.

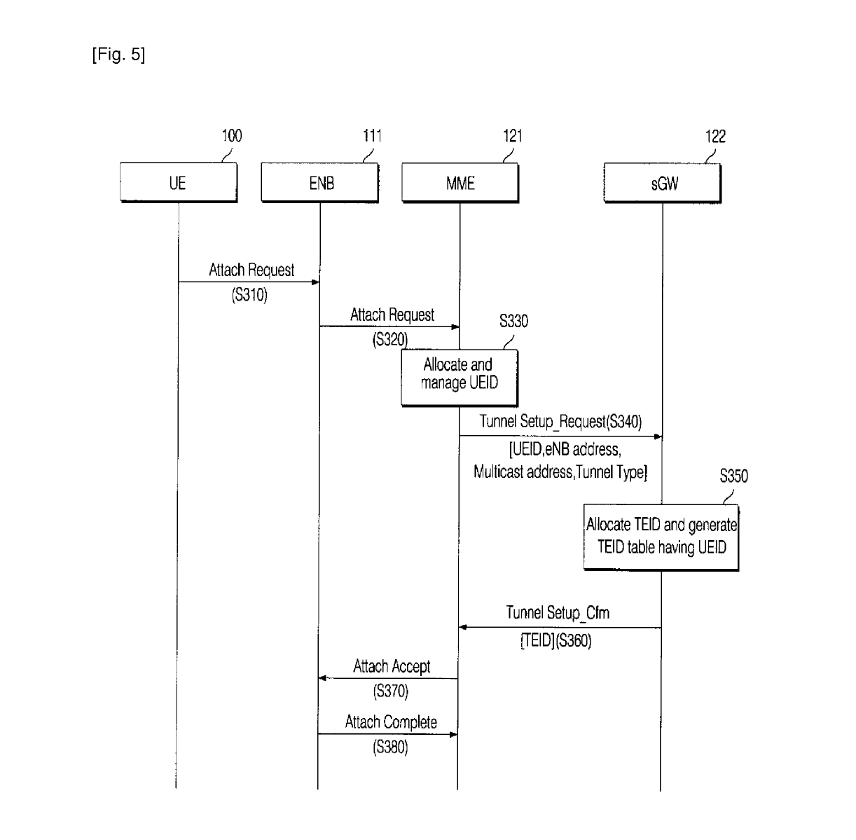

FIG. 5 is a flowchart illustrating a method for setting up a tunnel using equipment ID in accordance with an embodiment of the present invention.

Referring to FIG. 5, when UE 100 is turned on, the UE 100 requests connection to an ENB 111 in the same area, among a pluarity ENBs at step S310. The ENB 111 transmits the connection request of the UE 100 to the MME 121 according to the received connection request of the UE 100 at step S320.

The MME 121 allocates an UEID to the UE 100 according to the received connection request at step S330 and requests the sGW 122 to establish a tunnel for bearer setup at step S340. The MME 121 also transmits information including an UEID of the UE 100, an ENB address, a multicast address, and a tunnel type when requesting tunnel is established.

The sGW 122 allocates a new tunnel for the UE 100 according to the received tunnel setup request and generates a tunnel management table as shown in FIG. 4 based on the received information including the UEID of the UE 100, the ENB address, the multicast address, and the tunnel type at step S350.

At step S360, the sGW 122 transmits a response message for the tunnel setup request to the MME 122 with an allocated tunnel ID (TEID).

At step S370, the MME 121 transmits a response message of connection acceptance for the connection request from the ENB 111. At step S380, the ENB 111 transmits a message to the MME 121 to inform that connection is established, thereby enabling the UE 100 to use a service.

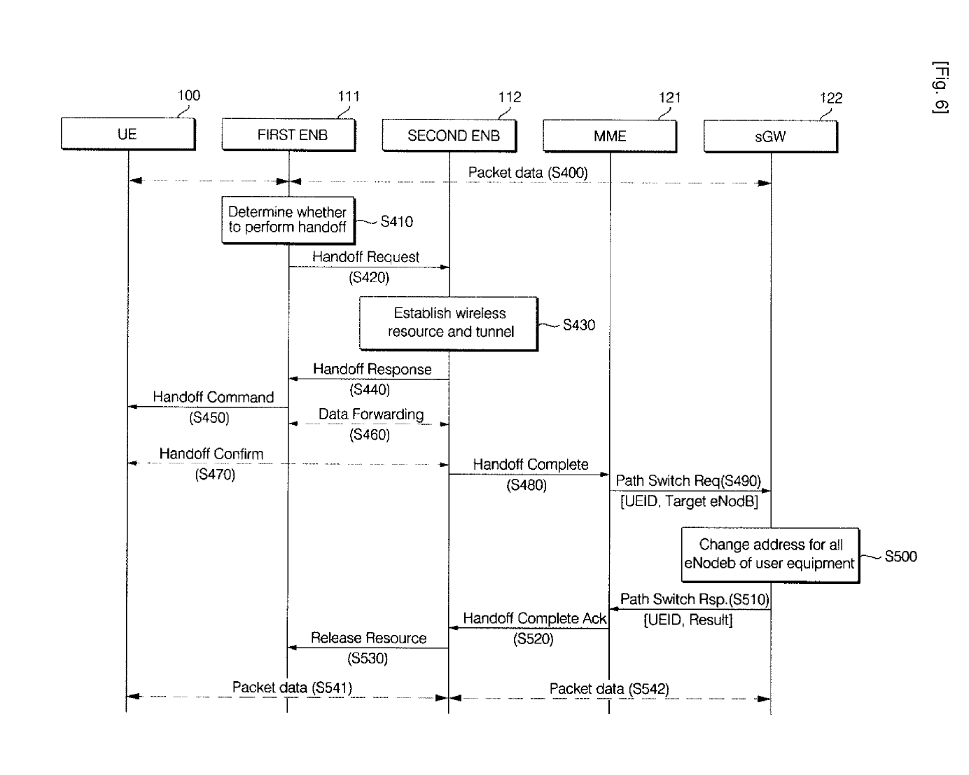

FIG. 6 is a flowchart illustrating a method for managing tunnels corresponding handoff in accordance with an embodiment of the present invention.

Referring to FIG. 6, at least one of tunnels is established corresponding to the number of services in use for user equipment (UE) 100 that uses at least one of services. If a plurality of tunnels are established to the UE 100 and the UE 100 moves while receiving packet data from a first ENB 111 and a sGW 122 at step S400, the first ENB 111 determines whether to perform handoff of the UE 100 based on a measurement report received from the UE 100 at step S410.

If it is determined to perform handoff, the first ENB 111 transmits a handoff request to a second ENB 112 in an area where the UE 100 moves to at step S420. The second ENB 112 receives the handoff request, sets up a radio resource, and sets up a tunnel between the second ENB 112 and the sGW 122 at step S430.

At step S440, the second ENB 112 transmits a response message for the handoff request to the first ENB 111. At step S450, the first ENB 111 transmits a handoff command to the UE 100 so related communication of the UE 100 is transferred to the second ENB 112. At step S460, the first ENB 111 forwards data to the second ENB 112.

At step S470, the UE 100 transferred to the second ENB 112 through handoff transmits a handoff confirmation message to the second ENB 112 to inform the second ENB 112 of handoff completion. At step S480, the second ENB 112 receives the handoff confirmation message and transmits the handoff confirmation message from the UE 100 to the MME 121.

At step S490, the MME 121 transmits an UEID of the corresponding UE 100 and an address of the second ENB 112 to the sGW 122 in order to change an ENB address which is an address of data destination for all tunnels established to the UE 100 performing the handoff.

At step S500, the sGW 122 searches a TEID according to the received UEID from the MME 121 and updates the tunnel management table to change an ENB address with the received address of the second ENB, which is an address of data destination.

At step S510, the sGW 122 transmits a result of changing tunnel information for the received UEID from the MME 121. At step S520, the MME 121 transmits a response message for handoff completion to the second ENB 112. At step S530, the second ENB 112 releases the radio resource between the UE 100 and the first ENB 111. At steps S541 and S542, packet data of the UE 100 is transmitted from the sGW 122 to the UE 100 through the second ENB 112.

In the present embodiment, an UEID of UE 100 is shared between the MME 121 and the sGW 122, and tunnel establishment, tunnel release, and handoff are performed using the UEID as described above. Therefore, it is possible to change ENB addresses for all tunnels established to the UE 100 through one time transmission of an UEID in the present embodiment.

### INDUSTRIAL APPLICABILITY

The mobile communication system and the tunnel management method thereof according to the present invention share a user equipment identifier (UEID), a delimiter of user equipment (UE), and manage tunnels of the UE using the UEID. Therefore, efficiency of handoff process and tunnel management increases and system performance is improved because it is possible to manage tunnels using the UEID when the UE performs handoff.

1. A tunnel management method for a mobile communication system including an evolved radio access network having a plurality of access nodes where user equipment accesses, and a serving gateway connected to a mobility managing device for controlling mobility of the user equipment and for controlling tunnel management and traffic transmission of the user equipment, comprising:
at the serving gateway, receiving a tunnel information update request having a user equipment identifier of the user equipment from the mobility managing device when the user equipment performs handoff; and
updating tunnel information by changing address information of data destination for all tunnels having the user equipment identifier.

2. The tunnel management method of claim 1, wherein in said receiving a tunnel information update request, an address of an access node whereto the user equipment is transferred by handoff is received with the user equipment identifier.

3. The tunnel management method of claim 2, wherein said updating tunnel information includes:
searching tunnel identifiers having the user equipment identifier from a tunnel management table that stores information on tunnels; and
changing an address of data destination for all tunnels that are established to the user equipment with the address of the access node corresponding to the search result.

4. A tunnel management method of claim 1, further comprising:
at the serving gateway, receiving a tunnel setup request for the user equipment with the user equipment identifier from the mobility managing device when a new service is connected to the user equipment;
setting up a new tunnel for the user equipment corresponding to the tunnel setup request; and
storing information about the new tunnel in a tunnel management table with the user ID.

5. A tunnel management method of claim 4, wherein in said storing information, a tunnel identifier of the new tunnel, an address of data destination, a multicast address, an user equipment identifier of the user equipment, and a tunnel type are stored in the tunnel management table.

6. A tunnel management method of claim 4, further comprising releasing a tunnel established to the user equipment using the user identifier when a service of the user equipment is interrupted.

7. A mobile communication system including an evolved radio access network having a plurality of access nodes accessed to user equipment, and a serving gateway connected to a mobile management device for controlling mobility of the user equipment and for controlling tunnel management of the user equipment and traffic control,
wherein the serving gateway changes an address of data destination for all tunnels established to the user equipment using a user equipment identifier allocated to the user equipment when the user equipment is transferred to one of the plurality of access notes.

8. The mobile communication system of claim 7, wherein the serving gateway sets up a new tunnel to the user equipment when the user equipment uses a new service and stores information including a user equipment identifier, an address of an access node which is a data destination, a multicast address, and a tunnel type.

9. The mobile communication system of claim 8, wherein the serving gateway receives the user equipment identifier and the address of the access node from the mobility management device, searches tunnels having the user equipment identifier from the tunnel management table, and changes an address of data destination for all of the searched tunnels to the address of the access node.
